(19) United States
(12) Patent Application Publication
(10) Pub. No.: US 2011/0230262 A1
(43) Pub. Date: Sep. 22, 2011

(54) GAMING SYSTEM AND METHOD OF DISPLAYING A DISPLAY SEQUENCE IN A GAMING SYSTEM

(76) Inventor: Suthan Shan, St. Clair (AU)

(21) Appl. No.: 13/050,261

(22) Filed: Mar. 17, 2011

(30) Foreign Application Priority Data
Mar. 17, 2010 (AU) 2010901116

(51) Int. Cl. A63F 13/00; A63F 9/24

(52) U.S. Cl. 463/30; 463/42; 463/43

(57) ABSTRACT

A gaming system including a data communication network connected to a master display controller, a plurality of local displays connected to a plurality of local display controllers, and a local data store for each local display controller. Each controller is associated with a respective one of the plurality of local displays to control the local display. The local data store stores graphics data for the same display sequence. The master display controller communicates with the local display controllers over the network to cause the local display controllers to display the display sequence with a time offset relative to one another such that at least one visual element contained in the display sequence appears to move between the plurality of local displays.

### RELATED APPLICATIONS

This application claims priority to Australian Patent Application No. 2010901116, having a filing date of Mar. 17, 2010, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a gaming system and method of displaying a display sequence in a gaming system.

It is known to arrange gaming machines so that players can participate in group games. In such a group game it is common for a plurality of gaming machines to be arranged in a bank next to one another. One or more of the players may trigger the group game. The group game may be played on a common display, typically a large screen video display, arranged above the gaming machines.

There is a need for an alternative technique that can be used in the display of a group game.

### BRIEF SUMMARY OF THE INVENTION

In a first aspect, the invention provides a gaming system comprising:
a data communication network;
a master display controller connected to the data communication network;
a plurality of local displays;
a plurality of local display controllers connected to the data communication network, each associated with a respective one of the plurality of local displays to control the local display; and
a local data store for each local display controller, each local data store storing graphics data for the same display sequence,
the master display controller arranged to communicate with the local display controllers over the network to cause the local display controllers to display the display sequence with a time offset relative to one another such that at least one visual element contained in the display sequence appears to move between the plurality of local displays.

In an embodiment, the gaming system comprises a further display under direct control of the master display controller and an additional memory local to the master display controller storing graphics data for the same display sequence, the master display controller arranged to control the further display to display the display sequence.

In an embodiment, the master display controller controls the further display such that at least one visual element contained in the display sequence appears to move between the further display and at least one of the local displays controlled by the local display controllers.

In an embodiment, the gaming system comprises a plurality of gaming devices each having a cabinet and wherein the plurality of local displays are mounted to respective ones of the plurality of cabinets and the plurality of local controllers and local data stores are disposed within respective ones of the plurality of cabinets.

In an embodiment, the gaming devices each have a game controller disposed within the respective cabinets for controlling a game to be played with the gaming device.

In an embodiment, the master display controller is arranged to issue initiate display sequence instructions to respective ones of the local display controllers at defined intervals to control the local game controllers to display the display sequence with a time offset relative to one another.

In an embodiment, each local data store stores a plurality of different display sequences and the master display controller controls which of the display sequences is displayed.

In a second aspect, the invention provides a master display controller for a gaming system comprising a data communication network, a plurality of local displays, a plurality of local display controllers connected to the data communication network, each associated with a respective one of the plurality of local displays to control the respective local displays, and a local data store for each local display controller, each local data store storing graphics data for the same display sequence,
the master display controller connected to the data communication network and arranged to communicate with the local display controllers over the network to cause the local display controllers to display the display sequence with a time offset relative to one another such that at least one visual element contained in the display sequence appears to move between the plurality of local displays.

In an embodiment, the gaming system comprises a further display under direct control of the master display controller and an additional memory local to the master display controller storing graphics data for the same display sequence, and the master controller is arranged to control the further display to display the display sequence.

In an embodiment, the master display controller controls the further display such that at least one visual element contained in the display sequence appears to move between the further display and at least one of the local displays controlled by the local display controllers.

In an embodiment, the master display controller is arranged to issue initiate display sequence instructions to respective ones of the local display controllers at defined intervals to control the local game controllers to display the display sequence with a time offset relative to one another.

In an embodiment, each local data store stores a plurality of different display sequences and the master display controller controls which of the display sequences is displayed.

In a third aspect, the invention provides a method of displaying a display sequence in a gaming system comprising:
communicating control data from a master display controller over a data communication network to respective ones of a plurality of local display controllers connected to the data communication network;
retrieving graphics data for the same display sequence at each of the local display controllers from respective ones of a plurality of local data stores, local to respective ones of the local display controllers; and
displaying the display sequence under the control of the local display controllers at local displays associated with respective ones of the local display controllers with display sequence on each local display displayed with a time offset relative to one another such that at least one visual element contained in the display sequence appears to move between the plurality of local displays.

In an embodiment, the method further comprises the master display controller directly controlling a further display to display the same display sequence from an additional memory local to the master display controller.

In an embodiment, the method comprises controlling the further display such that at least one visual element contained in the display sequence appears to move between the further display and at least one of the local displays controlled by the local display controllers.

In an embodiment, the method comprises the master display controller issuing initiate display sequence instructions to respective ones of the local display controllers at defined intervals to control the local game controllers to display the display sequence with a time offset relative to one another.

In an embodiment, each local data store stores a plurality of different display sequences and the method comprises the master display controller controlling which of the display sequences is displayed.

In a fourth aspect, the invention provides computer program code which when executed implements the above method.

In a fifth aspect, the invention provides a tangible computer readable medium comprising the computer program code.

### BRIEF DESCRIPTION OF SEVERAL VIEWS OF THE DRAWINGS

Exemplary embodiments of the invention are described in relation to the accompanying drawings, in which:

FIG. 1 is a block diagram of a gaming system.

FIG. 2 is a perspective view of a gaming device in the form of a stand alone gaming machine;

FIG. 3 is a block diagram of the functional components of a gaming machine;

FIG. 4 is a schematic diagram of the functional components of a memory;

FIG. 5 is a block diagram of a jackpot controller;

FIG. 6 shows four gaming machines with a display sequence displayed at an offset of one example; and

FIG. 7 shows four gaming machines with a display sequence displayed at an offset of another example.

### DETAILED DESCRIPTION OF THE INVENTION

Referring to the drawings, there is shown a gaming system having a plurality of local displays and a master display controller arranged to control a plurality of local display controllers associated with respective ones of the local display to cause the local displays to display the same display sequence at a time offset relative to one another such that a visual element contained in the display sequence appears to move between the plurality of local displays.

General System Configuration

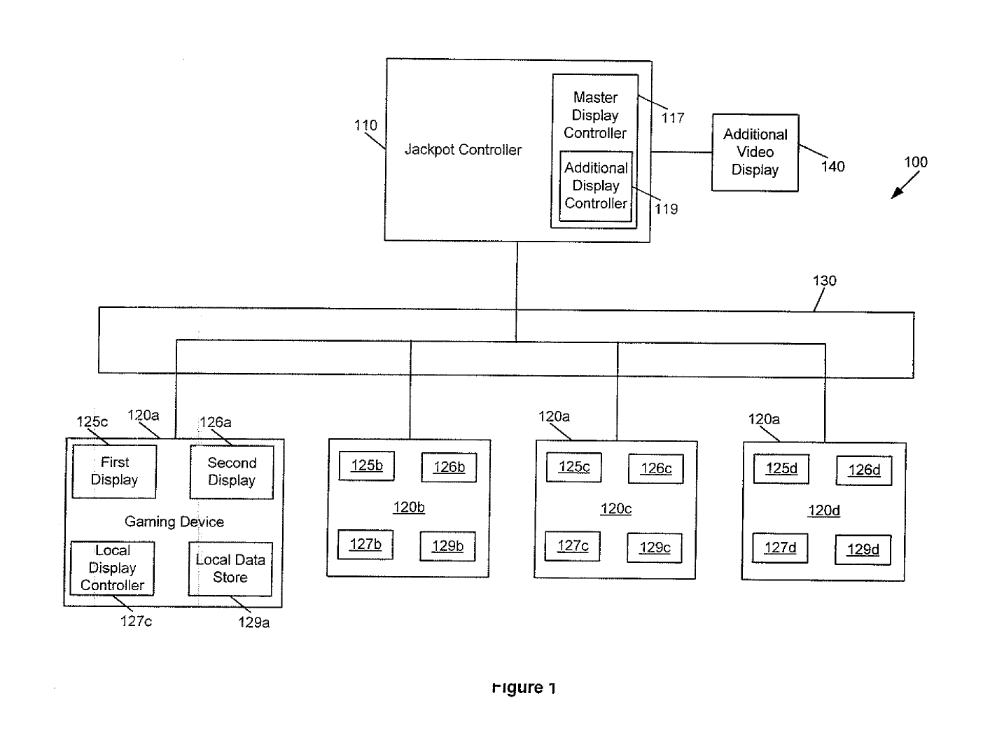

An example gaming system configuration 100, is shown in FIG. 1 where a jackpot controller 110 is in data communication with a plurality of gaming devices 120 over a network 130. Four gaming devices are shown in FIG. 1, however, a person skilled in the art will appreciate that the number of gaming devices can be varied. The gaming devices each have a pair of displays 125,126 at least one of which 126 functions as a local display 126 for the purpose of the gaming system. The gaming system 100 also has an additional video display 140 such as a large screen displayed positioned above a bank of gaming devices which is independent of the gaming devices and is also in data communication with the group game controller.

A person skilled in the art will appreciate that other components may form part of the gaming system 100 of Further, depending on the specific architecture, parts of the games executed by the gaming devices 120 could be executed on a server as described in detail below. However, in each embodiment, the local display controller 127 is provided within the cabinet of the gaming device and the display sequence is stored in a local data store 129 of the gaming device.

A person skilled in the art will also appreciate that other configurations may be viable. For example, with a server module disposed within a gaming device arranged to implement the jackpot controller in the manner described in Australian patent application 2008205413 filed 13 Aug. 2008.

Persons skilled in the art will also appreciate that the master display controller could also be a separate controller to the jackpot controller or part of a different controller such as a community game controller, e.g. in an embodiment where there is no jackpot controller.

Gaming Devices

Herein, the term gaming device is used to refer to any device used by a player to a play a game and specifically includes stand alone gaming machines and interactive video terminals which implement games in a client/server architecture.

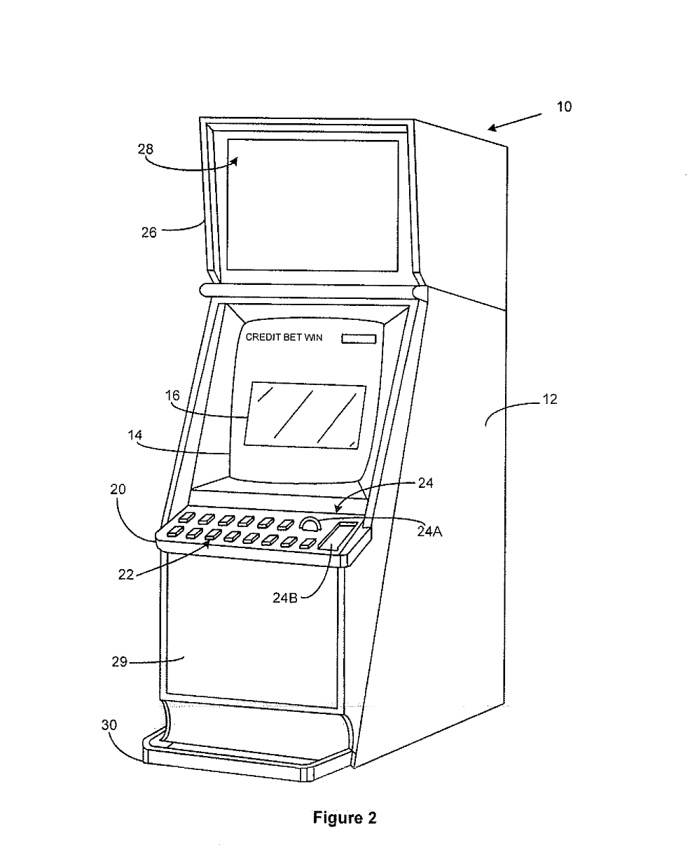

A gaming device in the form of a stand alone gaming machine 10 is illustrated in FIG. 2. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module comprising a reading device may also be provided for the purpose of reading a player tracking device, for example as part of a loyalty program. The player tracking device may be in the form of a card, flash drive or any other portable storage medium capable of being read by the reading device.

Artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 also includes a display 28 which may be of the same type as the display 14, or of a different type. The top box display 28 is used as the local display of the gaming system for display of the display sequence as described in further detail below.

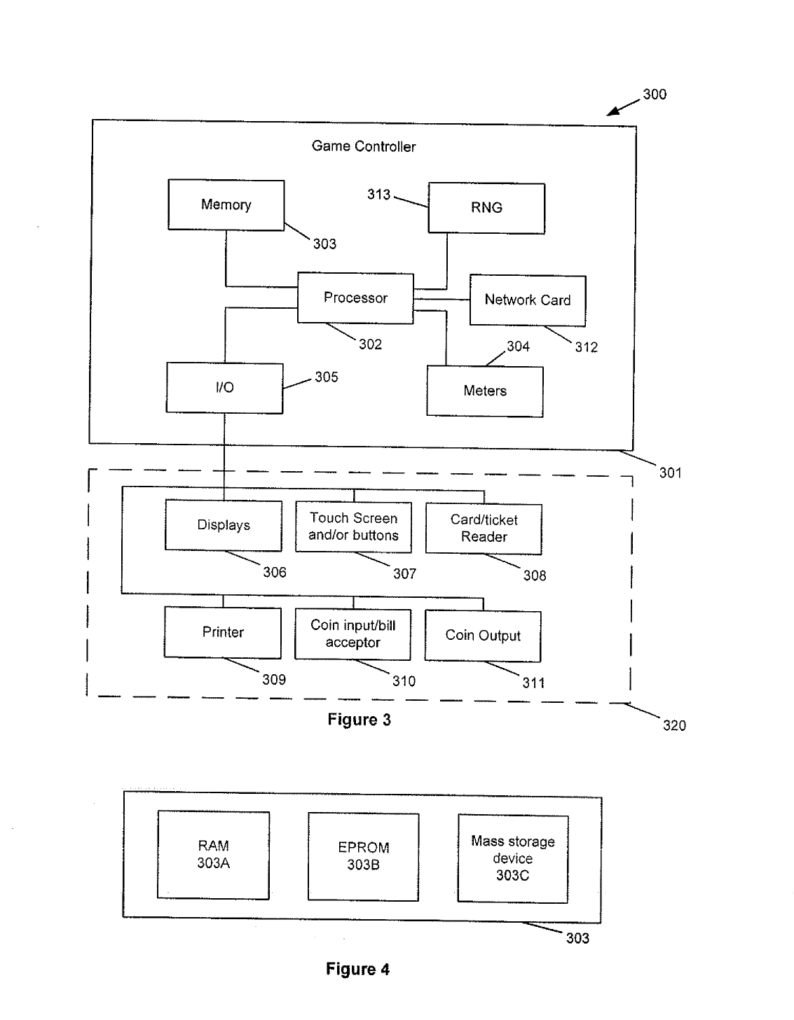

FIG. 3 shows a block diagram of operative components of a typical gaming machine which may be the same as or different to the gaming machine of FIG. 2.

The gaming machine 300 includes a game controller 301 having a processor 302. Instructions and data to control operation of the processor 302 are stored in a memory 303, which is in data communication with the processor 302. Typically, the gaming machine 300 will include both volatile and non-volatile memory and more than one of each type of memory, with such memories being collectively represented by the memory 303.

The gaming machine has hardware meters 304 for purposes including ensuring regulatory compliance and monitoring player credit, an input/output (I/O) interface 305 for communicating with peripheral devices of the gaming machine 300. The input/output interface 305 and/or the peripheral devices may be intelligent devices with their own memory for storing associated instructions and data for use with the input/output interface or the peripheral devices. A random number generator module 313 generates random numbers for use by the processor 302. Persons skilled in the art will appreciate that the reference to random numbers includes pseudo-random numbers.

In the example shown in FIG. 3, a player interface 320 includes peripheral devices that communicate with the game controller 301 including one or more displays 306, a touch screen and/or buttons 307, a card and/or ticket reader 308, a printer 309, a bill acceptor and/or coin input mechanism 310 and a coin output mechanism 311. Additional hardware may be included as part of the gaming machine 300, or hardware may be omitted as required for the specific implementation.

In addition, the gaming machine 300 may include a communications interface, for example a network card 312. The network card may, for example, send status information, accounting information or other information to a central controller, server or database and receive data or commands from the central controller, server or database.

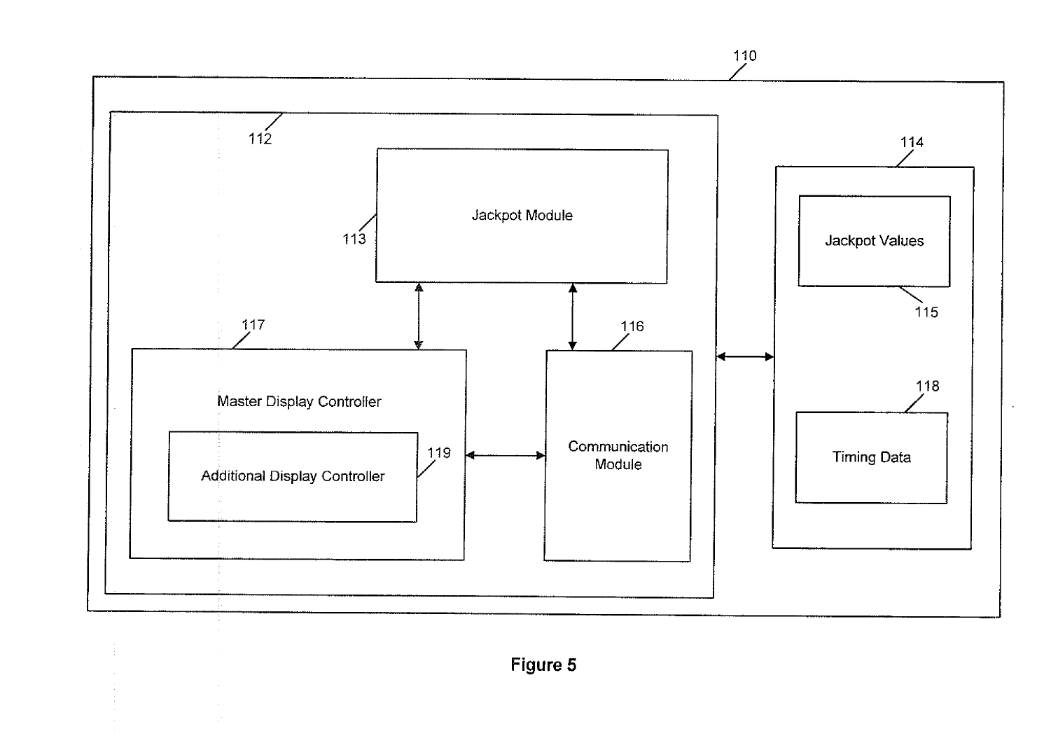

FIG. 4 shows a block diagram of the main components of an exemplary memory 303. The memory 303 includes RAM 303A, EPROM 303B and a mass storage device 303C. The RAM 303A typically temporarily holds program files for execution by the processor 302 and related data. The EPROM 303B may be a boot ROM device and/or may contain some system or game related code. The mass storage device 303C is typically used to store game programs, the integrity of which may be verified and/or authenticated by the processor 302 using protected code from the EPROM 303B or elsewhere.

It is also possible for the operative components of the gaming machine 300 to be distributed, for example input/output devices 306,307,308,309,310,311 to be provided remotely from the game controller 301.

A gaming device as indicated above may also take the form of a client/server architecture where a portion of the game is executed on the client and a portion of the game is executed on the server. In such embodiments, the client typically takes the form of an interactive video terminal which has a similar outward appearance to the gaming machine described above. A person skilled in the art will appreciate that the type of gaming device that is employed is not important to the present invention.

Jackpot Controller

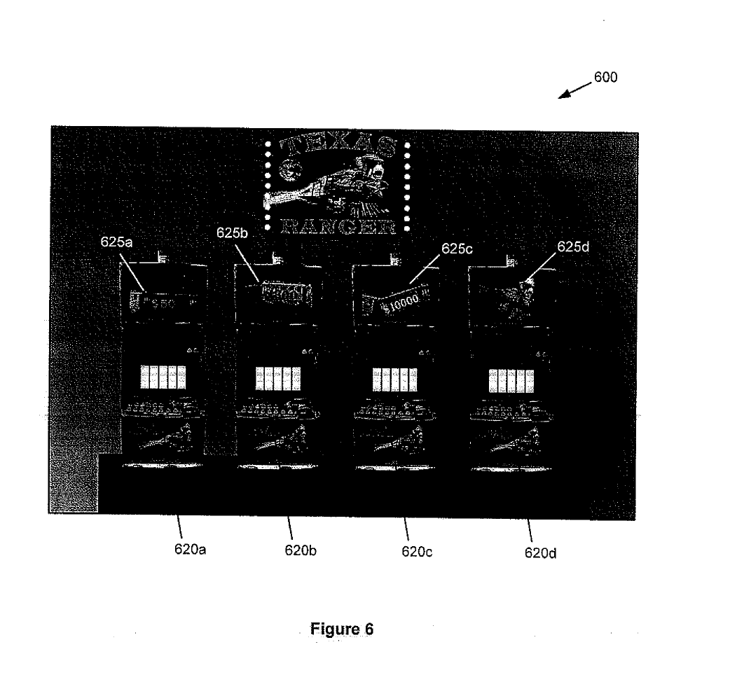

FIG. 5 shows a jackpot controller 110. As in some existing jackpot controllers, in the embodiments, the gaming devices determine whether the jackpot is to be awarded and the level of jackpot to be awarded and the jackpot controller 110 is arranged to implement the outcome of the award of the jackpot.

In this respect, FIG. 8 shows an example of a block diagram of gaming device. The gaming device includes a player interface 50 which enables the player to interact with the gaming device and which includes a first display 125 and second display 126 which are equivalent to the main display 14 and the top box display 28 described in relation to FIG. 2. The player interface 50 also includes the other functions that the player requires to interact with the game including to input wages, place wagers on the outcome of the game and receive awards etc. The game controller 60 is implemented by a processor 62 executing program code stored in a local memory 129 (which provides a local data store) to implement the game rules 641. The game controller 60 includes an outcome generator 622 which generates outcomes using random number generator 621 in response to placement of wagers and determines whether the player wins including whether the player wins a jackpot award. Upon a jackpot being awarded a communication module 624 advises the jackpot controller 110 as described further below. Otherwise, outcomes of the game are displayed on first display 125. During play, the second display 126 can either display parts of the game, or in one example, can display the current balance of the jackpot(s).

Persons skilled in the art will appreciate that while the various modules are shown as being implemented by the same processor 62 based on program code stored in memory 129, some of the components could be implemented as specific hardware modules or by other processors.

During play of the game, the gaming devices 120 communicate contributions to the jackpot to the jackpot controller which it uses to update the jackpot values 115 stored in the menu. The contributions may be calculated in accordance with techniques known in the art, for example as a percentage of turnover. In this respect, communication module 116 receives the contributions, passes them to the jackpot module 113 which itself is implemented by a processor 112 which updates the jackpot values stored in memory based on jackpot rules stored in the memory 114. When the jackpot is to be awarded, the jackpot module 113 initiates the master display controller 117 to control a display of the jackpot. The master display controller then obtains the value 115 of the jackpot to use in the display.

The master display controller then indicates to each of the local display controllers 623 of the individual gaming devices 120 that they should prepare for a jackpot award sequence. These communications being via the communications module 624 of the gaming devices 120. The jackpot controller in doing so indicates which of a plurality of display sequences 642 stored in a local memory is to be used.

The master display controller 117 then communicates initiate display sequence commands to each of the gaming devices 120 at defined time intervals. Upon receiving the command to display, the local display controller 127 begins to display the display sequence 642 which is the graphics data stored within the memory 129. The graphics of the display sequence are arranged such that an object moves in a defined direction within the top box display of the gaming device, for example left to right. Accordingly, the master display controller 117 will cause the left most gaming device to begin to display the display sequence first. The defined time period will depend upon the period of time that it takes for a visual element to move across the individual display. For example, if the visual element is a train and it takes two seconds to move across the display of one the gaming devices, then the defined time offsets should be 2 seconds such that the display sequence on the second machine does not initiate until the display sequence has reached a point on the first gaming device where the train is leaving the first gaming device, after which the train is intended to appear on the next gaming device. Accordingly, in the example of the train, by initiating the same display sequence at offset times the train will appear to move across the bank of gaming devices.

This technique is advantageous in that while co-ordinated by the master controller, the display at the individual gaming devices 120 is under the control of a local display controller 623 based on data stored in a local memory 64, and as such very little bandwidth is used in the communication of the sequence.

In one example, the display is caused to show the train moving until it stops at which time it can be indicated to the winning player of the jackpot that they have won the jackpot by data on the display.

Persons skilled in the art will appreciate that the train need not necessarily move from left to right. Persons skilled in the art will also appreciate in some embodiments there will be a number of different display sequences, for example corresponding to different prizes. In such embodiments, the master display controller communicates to each of the gaming devices which sequence is to be used prior to initiating the sequence. Further, while the sequence will typically be display on the top box display, the sequence may be displayed on the main display in some embodiments. In some embodiments, the sequence may be displayed on both displays.

### EXAMPLES

### Example 1

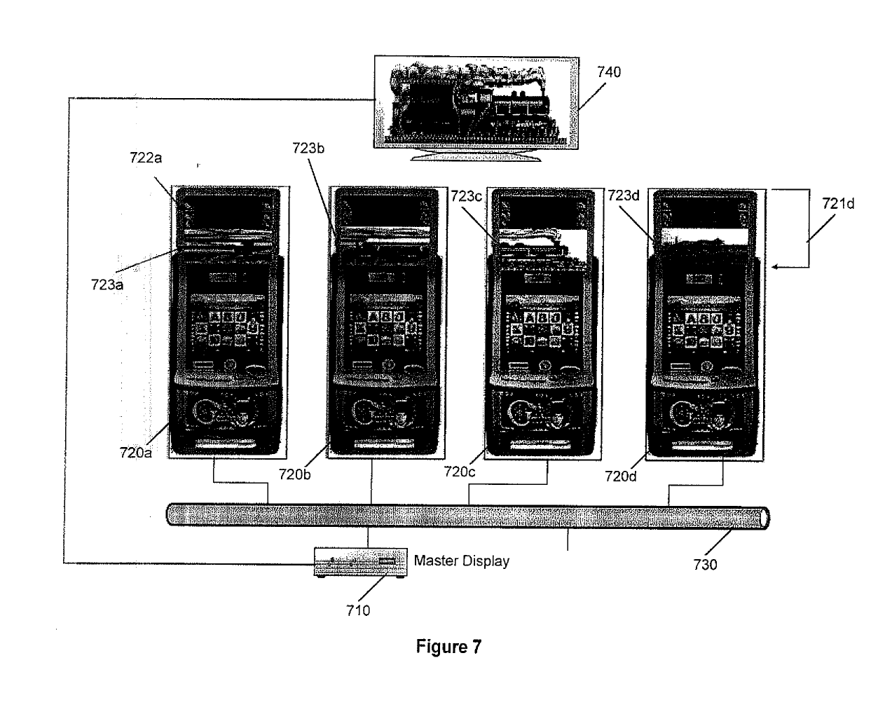

As shown in FIG. 6 a video image of a train moves from top box to top box, 625a to 625d, on a bank of gaming machines 620a to 620d. The train has a number of carriages or freight cars and one carriage or freight car or engine is shown on each machine in FIG. 6.

The carriages on the train display various prize levels such as 1st class (jackpot 1), 2nd class (jackpot 2), prize values, multipliers, free games, bonus prizes etc. The carriages might display a class of game e.g. $ machine.

The engine of the train can have a special prize. There may be more than one engine. In the example, a freight car does not display a prize but if a freight car stops on a machine, the freight is unloaded to the machine (a mystery win). Alternatively, the freight car can be loaded with water, fuel, money, etc.

The master display controller communicates with the local display controllers of the gaming machines such that the respective local display controllers control when the display sequence is displayed on displays 625a to 625d such that the train moves around the bank of machines. That is, the display sequence is first started on display 625a then on display 625b etc from left to right.

When the train stops, the prize shown on a prize carriage is paid to the player. Once the prizes are paid, the machine top box displays return to a display of game names.

### Example 2

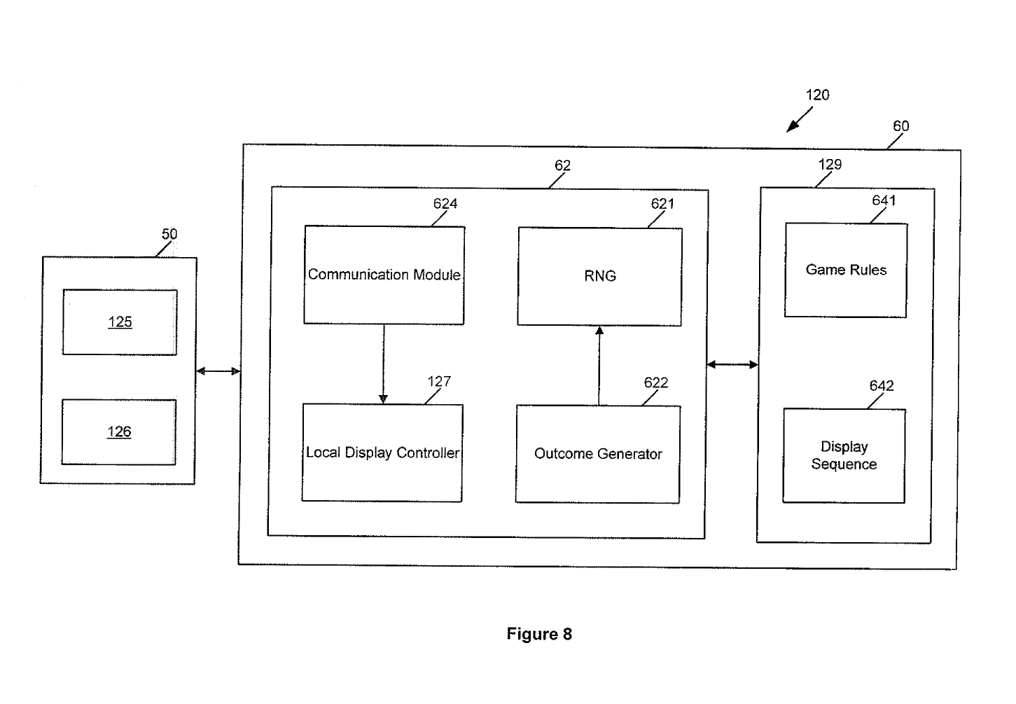

FIG. 7 shows a further arrangement where a master display controller 710 is connected over a network 730 to a plurality of electronic gaming machines 720. Each of the gaming machines 720 has a liquid crystal display top box 721 which is divided into two sections. A first section 722 where the values of the jackpot are displayed and a second section 723 where the display sequence is displayed. In this case, a train is shown as moving within display area 723A across the screen. This example also shows a display of the train being made on additional display 740 to indicate that a jackpot is in progress.

In a further example, display of movement of the visual element, in this case a train, can begin on additional display 740 before moving onto display 723A.

Further aspects of the method will be apparent from the above description of the system. It will be appreciated that at least part of the method will be implemented digitally by a processor. Persons skilled in the art will also appreciate that the method could be embodied in program code. The program code could be supplied in a number of ways, for example on a tangible computer readable storage medium, such as a disc or a memory (for example, that could replace part of memory 103) or as a data signal (for example, by transmitting it from a server). Persons skilled in the art, will appreciate that program code provides a series of instructions executable by the processor.

It will be understood to persons skilled in the art of the invention that many modifications may be made without departing from the spirit and scope of the invention, in particular it will be apparent that certain features of the above examples and embodiments of the invention can be employed to form further embodiments. For example, the display sequence need not only be displayed in the context of a jackpot award but can be used for other reasons, such as an attract sequence.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A gaming system comprising:
a data communication network;
a master display controller connected to the data communication network;
a plurality of local displays;
a plurality of local display controllers connected to the data communication network, each associated with a respective one of the plurality of local displays to control the local display; and
a local data store for each local display controller, each local data store storing graphics data for the same display sequence,
the master display controller arranged to communicate with the local display controllers over the network to cause the local display controllers to display the display sequence with a time offset relative to one another such that at least one visual element contained in the display sequence appears to move between the plurality of local displays.

2. A gaming system as claimed in claim 1, comprising a further display under direct control of the master display controller and an additional memory local to the master display controller storing graphics data for the same display sequence, the master display controller arranged to control the further display to display the display sequence.

3. A gaming system as claimed in claim 2, wherein the master display controller controls the further display such that at least one visual element contained in the display sequence appears to move between the further display and at least one of the local displays controlled by the local display controllers.

4. A gaming system as claimed in claim 1, comprising a plurality of gaming devices each having a cabinet and wherein the plurality of local displays are mounted to respective ones of the plurality of cabinets and the plurality of local controllers and local data stores are disposed within respective ones of the plurality of cabinets.

5. A gaming system as claimed in claim 4, wherein the gaming devices each have a game controller disposed within the respective cabinets for controlling a game to be played with the gaming device.

6. A gaming system as claimed in claim 1, wherein the master display controller is arranged to issue initiate display sequence instructions to respective ones of the local display controllers at defined intervals to control the local game controllers to display the display sequence with a time offset relative to one another.

7. A gaming system as claimed in claim 1, wherein each local data store stores a plurality of different display sequences and the master display controller controls which of the display sequences is displayed.

8. A master display controller for a gaming system comprising a data communication network, a plurality of local displays, a plurality of local display controllers connected to the data communication network, each associated with a respective one of the plurality of local displays to control the respective local displays, and a local data store for each local display controller, each local data store storing graphics data for the same display sequence,
the master display controller connected to the data communication network and arranged to communicate with the local display controllers over the network to cause the local display controllers to display the display sequence with a time offset relative to one another such that at least one visual element contained in the display sequence appears to move between the plurality of local displays.

9. A master display controller as claimed in claim 8, wherein the gaming system comprises a further display under direct control of the master display controller and an additional memory local to the master display controller storing graphics data for the same display sequence, and the master controller is arranged to control the further display to display the display sequence.

10. A master display controller as claimed in claim 9, wherein the master display controller controls the further display such that at least one visual element contained in the display sequence appears to move between the further display and at least one of the local displays controlled by the local display controllers.

11. A master display controller as claimed in claim 8, wherein the master display controller is arranged to issue initiate display sequence instructions to respective ones of the local display controllers at defined intervals to control the local game controllers to display the display sequence with a time offset relative to one another.

12. A master display controller as claimed in claim 8, wherein each local data store stores a plurality of different display sequences and the master display controller controls which of the display sequences is displayed.

13. A method of displaying a display sequence in a gaming system comprising:
communicating control data from a master display controller over a data communication network to respective ones of a plurality of local display controllers connected to the data communication network;
retrieving graphics data for the same display sequence at each of the local display controllers from respective ones of a plurality of local data stores, local to respective ones of the local display controllers; and
displaying the display sequence under the control of the local display controllers at local displays associated with respective ones of the local display controllers with display sequence on each local display displayed with a time offset relative to one another such that at least one visual element contained in the display sequence appears to move between the plurality of local displays.

14. A method as claimed in claim 13, further comprising the master display controller directly controlling a further display to display the same display sequence from an additional memory local to the master display controller.

15. A method as claimed in claim 14, comprising controlling the further display such that at least one visual element contained in the display sequence appears to move between the further display and at least one of the local displays controlled by the local display controllers.

16. A method as claimed in claim 13, comprising the master display controller issuing initiate display sequence instructions to respective ones of the local display controllers at defined intervals to control the local game controllers to display the display sequence with a time offset relative to one another.

17. A method as claimed in claim 13, wherein each local data store stores a plurality of different display sequences and the method comprises the master display controller controlling which of the display sequences is displayed.

18. A method as claimed in claim 13, further comprising executing computer program code for communicating control data from a master display controller over a data communication network to respective ones of a plurality of local display controllers connected to the data communication network, for retrieving graphics data for the same display sequence at each of the local display controllers from respective ones of a plurality of local data stores, local to respective ones of the local display controllers; and displaying the display sequence under the control of the local display controllers at local displays associated with respective ones of the local display controllers with display sequence on each local display displayed with a time offset relative to one another such that at least one visual element contained in the display sequence appears to move between the plurality of local displays.

19. A method as claimed in claim 18, further comprising storing said computer program code in a tangible computer readable medium.
